(19) United States
(12) Patent Application Publication
(10) Pub. No.: US 2017/0287062 A1
(43) Pub. Date: Oct. 5, 2017

(54) SELF-ADJUSTING BID-MANAGEMENT SYSTEM

(71) Applicant: International Business Machines Corporation, Armonk, NY (US)

(72) Inventor: Manish Gupta, New Delhi (IN)

(21) Appl. No.: 15/086,199

(22) Filed: Mar. 31, 2016

(51) Int. Cl. G06Q 30/08; G06Q 10/06

(52) U.S. Cl. CPC G06Q 30/08; G06Q 10/06313

(57) ABSTRACT

A method and associated systems for a self-adjusting bid-management system. An automated auctioneering system creates a bid topology that represents a set of tasks to be bid upon and a set of dependencies among those tasks. The system augments the topology with metadata that identifies rules, constraints, and functional and nonfunctional requirements of the tasks. The system solicits bids for each task from a set of electronic bidding systems, where limitations are placed on the bids as a function of the metadata. As each bid arrives, the system determines whether it is a winning bid and, if necessary, revises the topology to accommodate modifications necessitated by the bid and then resolicits bids for the revised project. This procedure repeats until bidding ends, either because of an elapse of a specific duration of time or because winning bids have been received for all tasks of the topology.

### TECHNICAL FIELD

The present invention relates to automating the operation of a bid-management or reverse-auction system in a brokered environment in which a resource-consumer requests bids for computing resources.

### BACKGROUND

Modern computing environments, especially cloud-computing environments, may comprise enormous numbers of components, and these components may be associated with each other in complex dependency relationships. In such environments, upgrade, migration, and other types of large-scale projects can comprise a huge number of subtasks that may change without warning as other tasks are better defined.

Such changes can happen when soliciting contractor bids to perform specific subtasks. A bid that, for example, proposes performing one set of subtasks may result in an addition, deletion, or redefinition of other subtasks or of a dependency relationship among such subtasks. In one example, if a vendor bidding on a task of upgrading a software application proposes moving the application's users to the vendor's proprietary cloud platform, accepting that bid might create a need to add a new “application migration” task to the project definition.

In a perfect world, such a new migration task would be added to an existing project definition and bids for the revised project tasks would be resolicited. Manual request-for-bid efforts and known computerized reverse-auction systems, however, generally do not know how respond to such bids. In most cases, if considering a bid proposal would require redefinition of a project or resolicitation of bids for any revised tasks of the project, that proposal would be discarded as being nonresponsive. This can result in inefficient auction results, a fact that is especially true when bidders' proposed revisions would have streamlined an original project definition.

When managing bids for a large or complex project, it would be difficult or impossible for a human bid manager to identify direct and indirect effects of a bid that may impact many layers of dependencies among a volatile set of project tasks. It would be even more difficult for a human manager to timely and accurately revise project requirements and resolicit bids in response to such bid proposals.

A means is thus required to identify a valid bid that necessitates adjusting project requirements, task breakdowns, dependency relationships among those tasks, intrinsic or extrinsic project constraints, and other components of a proposed project; to respond to that bid by automatically adjusting a project definition, and to then resolicit bids for the adjusted project.

### BRIEF SUMMARY

A first embodiment of the present invention provides a self-adjusting bid-management system comprising a processor of a computer system, a memory coupled to the processor, and a computer-readable hardware storage device coupled to the processor, the storage device containing program code configured to be run by the processor via the memory to implement a method for a self-adjusting bid-management system, the method comprising:

the processor identifying a bid topology that comprises a set of nodes and a set of edges,

wherein each node of the set of nodes represents a task of a set of project tasks,

wherein a first edge of the set of edges represents a dependency relationship between a first pair of tasks of the set of project tasks, and

wherein the first edge connects a pair of nodes of the set of nodes that represent the first pair of tasks;

the processor building a bid model that comprises the bid topology and a set of project metadata from which may be inferred characteristics of the bid topology;

the processor soliciting a set of bids from a set of bidders;

the processor receiving a first bid from a first bidder in response to the soliciting, wherein the first bid proposes a first bid amount to perform one or more tasks of the set of project tasks;

the processor determining whether the first bid is a winning bid;

the processor ascertaining whether to revise the bid model as a function of the receiving and the determining;

the processor, if having ascertained that the model should be revised, revising the bid model and resoliciting another set of bids from the set of bidders as a function of the revised bid model;

the processor repeating the receiving, the determining, the ascertaining, and the revising and resoliciting until an occurrence of a condition that terminates the bidding process.

A second embodiment of the present invention provides method for a self-adjusting bid-management system, the method comprising:

a processor of the bid-management system identifying a bid topology that comprises a set of nodes and a set of edges,

wherein each node of the set of nodes represents a task of a set of project tasks,

wherein a first edge of the set of edges represents a dependency relationship between a first pair of tasks of the set of project tasks, and

wherein the first edge connects a pair of nodes of the set of nodes that represent the first pair of tasks;

the processor building a bid model that comprises the bid topology and a set of project metadata from which may be inferred characteristics of the bid topology;

the processor soliciting a set of bids from a set of bidders;

the processor receiving a first bid from a first bidder in response to the soliciting, wherein the first bid proposes a first bid amount to perform one or more tasks of the set of project tasks;

the processor determining whether the first bid is a winning bid;

the processor ascertaining whether to revise the bid model as a function of the receiving and the determining;

the processor, if having ascertained that the model should be revised, revising the bid model and resoliciting another set of bids from the set of bidders as a function of the revised bid model;

the processor repeating the receiving, the determining, the ascertaining, and the revising and resoliciting until an occurrence of a condition that terminates the bidding process.

A third embodiment of the present invention provides a computer program product, comprising a computer-readable hardware storage device having a computer-readable program code stored therein, the program code configured to be executed by a self-adjusting bid-management system comprising a processor, a memory coupled to the processor, and a computer-readable hardware storage device coupled to the processor, the storage device containing program code configured to be run by the processor via the memory to implement a method for a self-adjusting bid-management system, the method comprising:

the processor identifying a bid topology that comprises a set of nodes and a set of edges,

wherein each node of the set of nodes represents a task of a set of project tasks,

wherein a first edge of the set of edges represents a dependency relationship between a first pair of tasks of the set of project tasks, and

wherein the first edge connects a pair of nodes of the set of nodes that represent the first pair of tasks;

the processor building a bid model that comprises the bid topology and a set of project metadata from which may be inferred characteristics of the bid topology;

the processor soliciting a set of bids from a set of bidders;

the processor receiving a first bid from a first bidder in response to the soliciting, wherein the first bid proposes a first bid amount to perform one or more tasks of the set of project tasks;

the processor determining whether the first bid is a winning bid;

the processor ascertaining whether to revise the bid model as a function of the receiving and the determining;

the processor, if having ascertained that the model should be revised, revising the bid model and resoliciting another set of bids from the set of bidders as a function of the revised bid model;

the processor repeating the receiving, the determining, the ascertaining, and the revising and resoliciting until an occurrence of a condition that terminates the bidding process.

### BRIEF DESCRIPTION OF THE DRAWINGS

FIG. 1 shows the structure of a computer system and computer program code that may be used to implement a method for a self-adjusting bid-management system in accordance with embodiments of the present invention.

FIG. 2 shows an architecture of a system for a self-adjusting bid-management system in accordance with embodiments of the present invention.

FIG. 3 is a flow chart that illustrates steps of a method for a self-adjusting bid-management system in accordance with embodiments of the present invention.

### DETAILED DESCRIPTION

The present invention is a self-adjusting bid-management system that solicits bids from vendors for one or more subtasks of a planned project, automatically revises a project definition as a function of incoming bids, and allows bidders to automatically restructure their bids in response to the project revisions.

Although elements of the present invention may be used to automate some aspects a reverse-auction or bid-solicitation system that interfaces with both computerized and manual bidding mechanisms, the present invention is primarily intended as a means of adding functionality to and improving efficiency of interactions between a certain class of computerized reverse-auction auctioneering systems and two or more computerized bidding systems.

These improvements solve a technical problem that arises solely in computerized reverse-auction systems by allowing an automated auctioneering system to automatically revise its internal bid-topology data structure in response to automated bids that would otherwise be rejected if they require a redefinition of the tasks being bid upon. When implemented as part of such a distributed bid-management platform, embodiments of the present invention, rather than discarding such bids (and ignoring the possibility that the bidder may be proposing a cost-effective alternative solution), allow an automated bid-management system to consider more types of bids than would be possible with known computerized reverse-auction systems.

The present invention thus does not merely automate long-held practices of human behavior. The problem it solves, is intrinsic to certain types of computerized auctioning systems that solicit bids on complex projects that comprise large numbers of interrelated subtasks. This problem is the need to coordinate multiple distributed bidding computer systems that may propose simultaneously received bids that each alter dependencies and other constraints upon a subtasks of a project out to bid, such that, if considered, the received bid would dynamically change rules by which other bidders' bids may be structured or constrained.

For example, if a solicitor requests bids on a project that comprises several thousand subtasks organized into a hundred groups, and where the subtasks and groups are related in dependency relationships, a human-to-human bidding practice could solicit bids on only the entire project, or on subsets of those subtasks or groups that each comprise a functional task capable of being performed independently of other components of the project.

A computerized auction system, however, may solicit structured bid requests that allow a bidder to place a bid on every subtask or group. The system might offer further functionality that responds to a bid on a dependent subtask by requiring a bid to also bid on a second subtask upon which the dependent task depends, thus preventing bidders from proposing more innovative bids that might result in cost-effective solutions that the bid-solicitor had not thought of. In other cases, the system might simply accept bids on every component of the project and require a human expert to manually review and discard impractical bill combinations after the end of bidding. The technical advantages of using a computerized distributed auctioneering system, which allow a solicitor to solicit bids on an enormously complex project, may thus create problems after the close of bidding that mitigate those advantages.

In one example, a bidder may place a bid on a first subtask that proposes a first solution. If the first solution requires performance of a new subtask that had not previously existed, the auctioning system, upon the close of bidding, will not have solicited competitive bids for that new subtask because the new subtask was not known at the time of the original solicitation.

Embodiments of the present invention would allow a computerized distributed auction system to dynamically add that new subtask to its original request for bids, along with a rule that the new task be made available for bid upon to bidders that have placed a bid on the first subtask that proposes the first solution. This revision to the original bid request, because of the nature of computerized auction systems, may then be communicated to all systems currently bidding on the project, allowing those bidding systems to further revise their bids in response, and then further allowing the auction system to further revise its bid request in response to those further revised bids. Such an automated, dynamically self-adjusting bidding system is thus not a longheld human activity because it solves a technical problem that does not exist in human-to-human auctions.

Similarly, embodiments of the present invention allow an auctioning system to dynamically or continuously revise its bid solicitation if a bid proposes a solution that would allow a subtask to be deleted from the project or from a group, or that changes a dependency or other relationship among subtasks or groups. As above, these solution solve a type of problem that does not occur outside of computerized bidding systems because only computerized bidding systems offer functionality that allows a bid-soliciting party to receive and consider multiple contemporaneous bids that do not fully comply with an original bid request, or that propose alternative methods of meeting the bid-solicitor's needs. As before, embodiments address this problem by allowing the bid-solicitor to dynamically create a new model of the project that allows the bid solicitation to be revised without interrupting an ongoing bidding process. In more sophisticated embodiments, a bidding system may automatically, by means of local rules, revise its earlier bid in response to the revision to the bid solicitation. Thus, if a partially noncompliant bid is placed by one bidding system, embodiments of the present invention may allow an entire distributed bidding platform, including the bid-soliciting system and multiple remote bidding systems, to automatically, iteratively, and almost instantaneously adjust their proposals so that all outstanding bids are always consistent with each other and the latest version of the bidding rules comprised by the bid request.

Embodiments also allow known computerized reverse-auction systems to produce more efficient and more cost-effective results by allowing a project definition being bid upon to automatically revise itself in order to accommodate unexpected bid proposals. Embodiments also allow automated bidding systems to in turn revise amounts, scopes, and structures of prior bids in response to project revisions suggested by competing bids.

Unlike a manual request-for-bids solicitation or other types known computerized reverse-auction systems, embodiments of the present invention thus facilitate a self-adjusting bidding effort that, by iteratively fine-tuning internal data structures with each incoming bid, coordinates efforts of competing bidders. Furthermore, embodiments accomplish this feat without requiring bidders to interact or requiring an auctioneer to redefine a project definition in response to a compelling bid proposal.

Without the instantaneous communications, modeling capabilities, and real-time feedback mechanisms of a distributed, computerized reverse-auction system, or other type of bidding system, (functionality that is robustly implemented in only the most advanced of such systems) the technical problem solved by the present invention would not arise. In other words, this problem arises because such systems provide functionality that has no analog in traditional non-computerized human-to-human bidding platforms. Because such systems, and the limitations they suffer, are inherently based in computer technology, the present invention may be considered to be a technical solution to a technical problem that is necessarily rooted in this one class of advanced computer-based bidding systems.

Embodiments of the present invention represent tasks of a planned project as a bid topology that might, for example, be represented as a directed graph in which each node represents a subtask and each edge connects two nodes that represent a pair of subtasks related by a dependency relationship.

Upon receiving a bid, the system automatically revises the bid topology as a function of changes to the project definition that may be necessitated by acceptance of the bid and then resolicits bids for remaining tasks of the revised project.

Bid solicitation is performed by means of computer-to-computer interaction between an embodiment of the present invention and compatible computerized bidding systems maintained by bidders. This communication mechanism allows bidders to respond automatically to revised project requirements and a resulting resolicitation.

If, for example, a first bidder places a bid on two subtasks, where the structure of the bid eliminates an existing third subtask, the present invention would automatically delete the corresponding third subtask node from the bid topology, further revise the bid topology by adjusting multiple levels of dependencies and subtasks that changed due to ripple effects of the deletion of the third subtask node, and then forward a resulting revised bid solicitation to the bidding systems. The bidding systems might then respond automatically, deleting any prior bid components related to the third subtask and adjusting other characteristics of earlier bids that were affected by the ripple-effect revisions to the bid topology.

In projects that comprise thousands of subtasks, many of which are related by layers of dependencies, this automated system makes possible a self-adjusting bidding procedure that could not possibly be replicated by mere human activity or behavior.

In a typical human-based approach (or in a system that merely duplicates human behavior), a business would solicit and receive bids on a project and, after receiving all bids, would select a subset of winning bids and then manually identify and reject bids that are inconsistent with project revisions necessitated by other winning bids. Such a manual procedure would likely produce different results than would the present invention.

Where the manual procedure could result in conflicting bids, receipt of bids on nonexistent subtasks, and a failure to solicit bids on subtasks that did not exist in the original project definition, the present invention automatically ensures that bids are automatically updated in response to each bid-triggered change to a project requirement. The automated procedure pf the present invention thus improves the functioning of existing bid-management systems, ensuring that all bids, at the time the bidding ends, are consistent with each other and with the most current project definition.

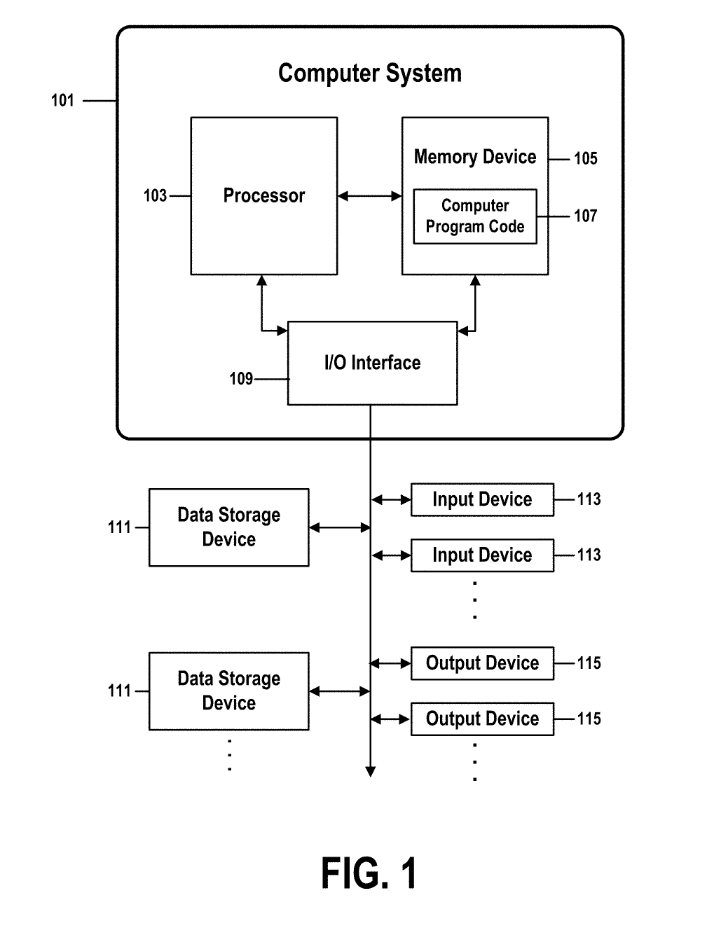

FIG. 1 shows a structure of a computer system and computer program code that may be used to implement a method for a self-adjusting bid-management system in accordance with embodiments of the present invention. FIG. 1 refers to objects 101-115.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for a self-adjusting bid-management system in accordance with embodiments of the present invention, and may implement other embodiments described in this specification, including the methods illustrated in FIGS. 1-3. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, nonremovable, read-only storage medium such as a Read-Only Memory (ROM) device 105, or may be accessed by processor 103 directly from such a static, nonremovable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the present invention discloses a process for supporting computer infrastructure, integrating, hosting, maintaining, and deploying computer-readable code into the computer system 101, wherein the code in combination with the computer system 101 is capable of performing a method for a self-adjusting bid-management system.

Any of the components of the present invention could be created, integrated, hosted, maintained, deployed, managed, serviced, supported, etc. by a service provider who offers to facilitate a method for a self-adjusting bid-management system. Thus the present invention discloses a process for deploying or integrating computing infrastructure, comprising integrating computer-readable code into the computer system 101, wherein the code in combination with the computer system 101 is capable of performing a method for a adjusting bid-management system.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise the computer-readable hardware storage device.

While it is understood that program code 107 for a self-adjusting bid-management system may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for a self-adjusting bid-management system is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

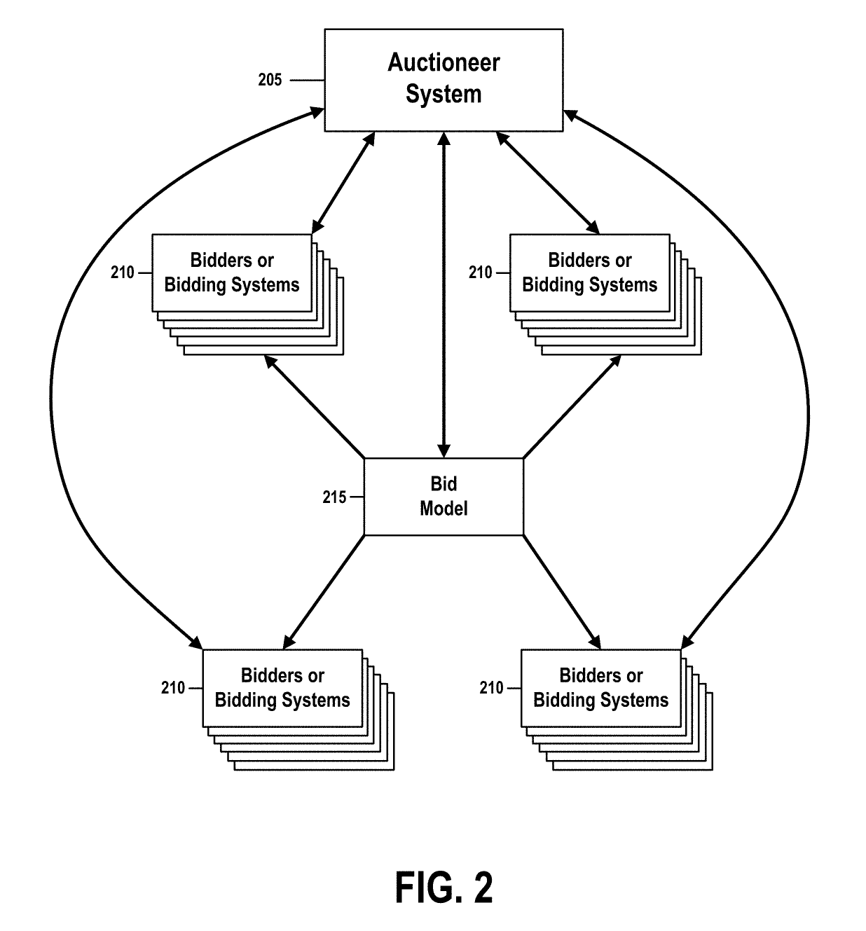

FIG. 2 shows an architecture of a system for a self-adjusting bid-management system in accordance with embodiments of the present invention. FIG. 2 shows elements identified by reference numbers 205-215.

Element 205 is an auctioneer system that performs methods of the present invention and, in particular, performs steps of a computerized bid-solicitation procedure described in FIG. 2.

This system 205 comprises one or more computer systems 101 of FIG. 1. Although not shown in FIG. 2, auctioneer system 205 may, as described in FIG. 1, further comprise one or more computerized storage devices 111, such as rotating disk drives, solid-state drives (SSD's), and optical storage devices capable of storing non-transient, non-signal data; one or more input devices 113; and one or more output devices 115.

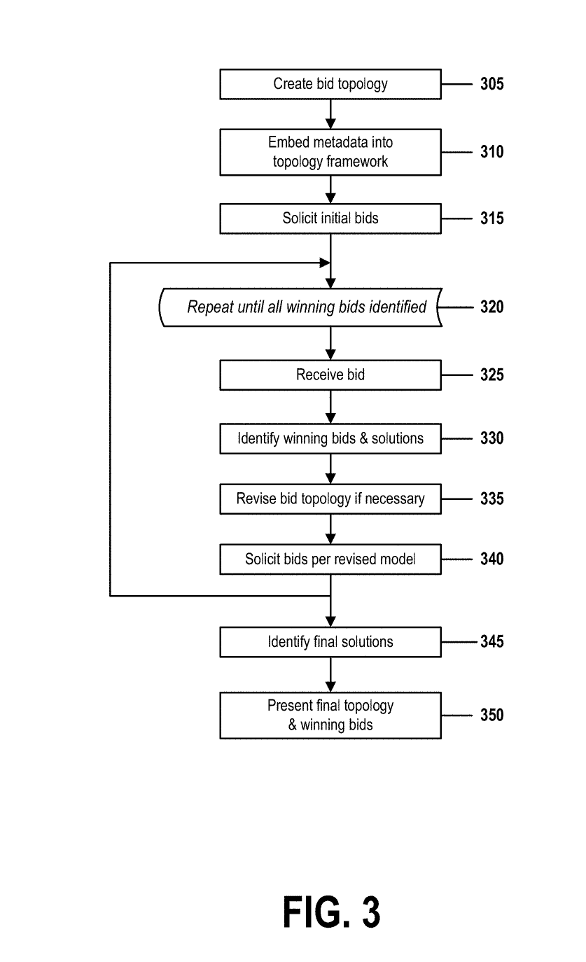

In some embodiments, auctioneer system 205 may comprise integrated or distinct components described in FIG. 3, such as a Topology Manager dedicated to functions related to revising or maintaining a topology of a bid model 215.

In some embodiments, auctioneer system 205 may be part of a larger bid-management system that may include other components related to scheduling, organizing, configuring, communicating, or otherwise managing an effort to solicit, receive, evaluate, and select bid proposals for work to be done by third-party bidders on tasks of a proposed project.

Elements 210 identify two or more bidders that communicate bids to the auctioneer system. Each bidder 210 may be an individual, a business, a system, or an other entity capable of bidding on a task in response to receiving a bid solicitation from auctioneer system 205.

Each bid may be communicated through any means known in the art, such as through a wired or wireless network, or by means of an interactive computer user interface, a mobile device, email, or via noncomputerized means, such as a hardcopy mailing.

Element 215 is a bid model that identifies a topology and metadata associated with the tasks to be bid on. Auctioneer system 205 may create this model, and then revises this model in response to bids received from bidders 210.

FIG. 3 is a flow chart that illustrates the steps of a method for a self-adjusting bid-management system in accordance with embodiments of the present invention. FIG. 3 contains steps 305-350, which may be performed by embodiments that incorporate the data structures of FIG. 2.

In step 305, one or more processors of auctioneer system 205 creates or receives a bid topology. As described above a bid topology represents a set of requirements of a project for which bids will be selected.

In examples used in this document, a bid topology takes the form of a directed graph in which the graph's nodes and edges respectively represent project tasks or subtasks and dependency relationships between pairs of those tasks or subtasks.

In other embodiments, the bid topology may be represented in any other way known in the art to be a method of representing objects related by directed relationships. Such representations may comprise a database, an ontology of a knowledgebase, a hierarchical directory, or other types of data structures.

In some embodiments the system 205 may automatically construct the bid topology as a function of expert knowledge of the project, of business or project documents, of manually entered data, from a configuration-management database or software tool, from discovery of an existing system or resource, or from other sources. In other embodiments, the bid topology may be received by the system 205 from a human operator or from another computerized system.

In a simple example, a business might wish to solicit bids to upgrade an existing e-commerce system. Here, an initial bid topology might represent the current system implementation that includes two local-area networks connected to each other by means a 50 Mbps router and to the Internet through a bidirectional 11 Gbps network backbone.

Each of the two local-area networks might further comprise sets of workstations and servers, each of which must be loaded with an operating system, network software, a database management system client, and an e-commerce application.

In this example, each of these elements would be represented in the bid topology as a node and each edge of the topology representation would represent a dependency between two elements. Therefore, if a first server runs a first instance of the Windows operating system, a node representing that Windows instance in the topology would be connected to a node representing the first server. That edge would represent a dependency of the operating-system instance upon the first server, where that dependency relationship identifies that the operating-system cannot be installed unless the first server is also installed.

In step 310, the system 205 embeds business-intelligence metadata into the bid topology as a set of tags. These tags identify attributes of the model elements of the bid topology that define the project to be bid upon. The tags may be embedded directly into the bid topology as an integrated data structure, or may be stored in a distinct data structure or database that is linked to or otherwise associated with the bid topology.

These tags may identify functional requirements of an element, such as a minimum acceptable capacity of a storage device, or a nonfunctional requirement like a system availability or a maximum allowable latency time. In some embodiments functional and nonfunctional requirements may be stored separately in a distinct data structure or database that is lined to or otherwise associated with the elements of the bid topology.

Other tags may, for example, identify: security requirements, such as HIPAA compliance or encryption standards; related contract terms like delivery incentives or termination dates; migration requirements like platform characteristics or accessibility requirements; and other attributes.

In this step, some tags may not yet be assigned even initial or default values. In some embodiments, the tags, elements, and dependency relationships among the elements may form a template or pattern model that may be reused for similar projects by assigning project-specific values to one or more of the template's tags. In some of these embodiments, a pre-existing pattern or template may be filled in by the auctioneer system 205 through a discovery mechanism that allows the system 205 to identify business intelligence data and automatically load it into appropriate locations of the topology model.

The system 205 may further employ business intelligence, discovered system attributes, expert knowledge, archived or historical data, performance and maintenance logs, and other information sources to add more sophisticated elements to the bid topology.

The topology model may, for example, be enhanced to identify bid constraints and rules that identify, for example: certain combinations of tasks that must be included in a single bid or that must be bid on by a same bidder; allowable combinations of bidders that may jointly submit a bid; identifications of certain bidders or classes of bidders that are allowed to bid on certain subtasks or classes of subtasks; or bid dependencies that identify elements that cannot be bid until certain other elements have already received winning bids.

Similarly, the system 205 may employ historical data, such as performance logs and maintenance records, to add or assign values to tags that identify requirements like minimum acceptable throughput or bandwidths, system availability figures, scalability requirements, or required storage capacities.

In some embodiments, these functions may be performed by a distinct Auction Topology Manager module of the auctioneer system 205. In such embodiments, the Auction Topology Manager will continue to be responsible for maintaining and updating the bid topology whenever it must undergo revisions, such as in step 335 of FIG. 2.

At the conclusion of step 310, the system 205 and its related components will have assembled a complex bid model that includes a topology of the tasks to be bid upon and the dependency relationships between those tasks; and sets of constraints, rules, functional requirements, and nonfunctional requirements that govern how bids must be constructed and submitted.

In step 315, the system solicits bids from the bidders through means known in the art, such as through network links to client applications running on bidder systems 210. In some embodiments, this solicitation will include a representation of the bid model that tells bidders what they are bidding on and identifies rules, constraints, and requirements that identify how bids should be constructed and submitted.

Step 320 begins an iterative process of steps 320-340 that runs continuously until the bidding procedure ends. In some embodiments, this iterative process is performed each time a bid is received.

In some embodiments the iterative process may conclude when winning bids have been identified for all biddable elements of the bid topology. In other embodiments, the process may conclude its last iteration when the system 205 detects an occurrence of a predetermined condition, such as an ending of a preset bidding period, or a failure of any bids to arrive during a certain period of time.

In step 325, the system 205 receives, in response to the solicitation of step 315, a bid from one or more bidders or bidding systems 210.

A bid may comprise any sort of information that may be required in order to respond to the bid solicitation of step 315 or 340. A bid may be created or transmitted, all or in part, either manually by a human bidder or automatically by a bidding system.

As with the bid solicitations of steps 315 and 340, bids may be received by any communications mean known in the art.

In some embodiments, a bid may comprise any information that the bidder or the auctioneer considers necessary or helpful in identifying specifics of the bidder's intent, or that is required or requested by the bid solicitation.

Each bid may, for example, identify:
one or more elements of the latest version of the bid topology for which bids had been solicited.
a description of the bidder's proposed solution for each element or combination of elements
a bid amount for each selected element. The bid amount may be a currency amount or another figure that identifies a value to be transferred by the solicitor to the bidder in consideration of the bidder's proposed solution.

Bids may be structured, or may comprise content, that is determined by the rules, constraints, functional requirements, and nonfunctional requirements of the bid topology. A bid may comprise attributes that may, subject to the rules, constraints, and requirements, characterize all or part of the bid.

In one example, in which an auctioneer solicits bids for a network-backbone element, the bid topology might comprise a nonfunctional requirement of a 100 Gps minimum bandwidth and a rule that the backbone must be able to interface to an existing fiber infrastructure. A bid that responds with a bid on that element might further comprise three sets of attributes associated with that bid, where the first attribute identifies a range of bandwidth values that would be provided by the bidder's proposal, the second attribute identifies types of infrastructure that may be interfaced to the proposed backbone, and the third attribute identifies additional costs that would be incurred by interfacing to each type of infrastructure.

In this example, a bid for the backbone element might also comprise bid constraints that identify Boolean constraints among attributes of that bid. Such a bid constraint might, for example, specify that a bid amount should be augmented by a value of the third attribute as a function of a selection of a value of the second attribute. For example, if the bid amount is $200,000, one value of the second attribute is “Fibre Channel infrastructure,” and one value of the third attribute is “$35,000,” the bid constraint might then automatically revise the bid amount to $235,000 if the soliciting entity selects a Fibre Channel interface from among options presented by the bid.

In some embodiments, such a revision might be performed by a software application submitted by a bidder, and in other embodiments it might be performed by the auctioneer system 205 in response to receiving a bid that comprises or otherwise identifies such constraints.

In some embodiments, the auctioneer system 205 may further determine in this step (or in a subsequent step of the iterative process of steps 320-340) whether the received bid is feasible or otherwise satisfies constraints, rules, or requirements that identify characteristics of a bid that make it valid or acceptable. A bid might, for example, be rejected if it arrives after a certain deadline, exceeds a maximum dollar amount, causes an entire project cost to exceed a maximum amount, does not reference an element upon which the bidded element depends, or otherwise fails to satisfy a constraint, rule, or requirement of the bid model or of the bid solicitation.

If a bid is not deemed to be a valid, feasible, or otherwise acceptable bid, the current iteration of iterative process of steps 320-340 ends and the procedure of FIG. 2 returns to step 320 for a next iteration.

In step 330, the auctioneer system 205 identifies whether the bid received in step 325 is a winning bid, or whether its receipt allows the system to identify a previously received bid as a winning bid.

The auctioneer system 205 may further in this step evaluate all received bids, all winning received bids, or all valid received bids and, as a function of the evaluating, identify one or more feasible partial solutions or feasible complete solutions.

A feasible solution is one that satisfies all the constraints, rules, functional requirements, and nonfunctional requirements of the bid model. A complete solution is one that comprises winning bids for all solicited elements of the bid topology, and that satisfies all rules, constraints, and requirements of the most current revision of the bid model. A partial solution is one that comprises winning bids for a subset of the solicited elements, where those winning bids satisfy all rules, constraints, and requirements of the most current revision of the bid model.

This evaluating may be performed by any means known in the art, such as a method of semantic analytics, syntactical analytics, or heuristics. The evaluating may thus not identify winning bids or solutions with absolute certainty, but may instead identify bids and solutions that have a higher probability of being winning bids or feasible solutions.

A bid may, for example, be selected as a winning bid if it proposes a bid price that is lower, or that is otherwise more desirable, than any previously received bid for a same combination of elements. In some cases, selecting a bid as a winning bid may further require satisfaction of certain rules, constraints, nonfunctional requirements, or functional requirements identified by a bid solicitation. In some embodiments, selecting a bid as a winning bid may further require satisfaction of one or more conditions, such as a requirement that winning bids for a particular element be awarded only to authorized contractors or a proscription against identifying a bid submitted by a bidder in a particular country or region as a winning bid.

In some embodiments, feasible solutions are computed as functions of winning bids. In other embodiments, winning bids are selected as a function of the winning bid determinations. In other words, a feasible solution may be identified by selecting a combination of winning bids that most cost-effectively satisfies all rules, constraints, and requirements of a bid model; or winning bids may be identified as those bids comprised by the most cost-effective feasible complete solution or by a most cost-effective combination of feasible partial solutions.

Designating a bid as a winning bid may be a function of an interaction between the bid and the auctioneer system 205. In one example, bid attributes comprised by the bid may cause the system 205 to adjust the bid price to an extent that the bid price exceeds a constraint on the total project cost that is comprised by the bid model.

In another example, if a bid on a first element proposes a solution that includes an additional cost, the auctioneer system may respond by identifying that bid as a winning bid for a new combination of elements. In this example, that new combination of elements might add to the first element a new second element that comprises tasks, rules, constraints, or requirements associated with the additional cost. In such a case, the bid might be tentatively identified as a winning bid for the new combination of elements, but might not affect the winning status of a previously received bid that addressed the first element without introducing the additional expense.

In step 335, the system 205 revises the bid topology if such a revision is necessitated by the bid received in step 325. In some embodiments, a revision might be performed only if the bid received in step 325 is identified as a winning bid in step 330 or if it results in a revision to previously computed feasible solutions that necessitate revisions.

In some cases, revisions may be necessitated by dependency relationships associated with model elements, by model semantics (or rules) that, when applied to a partial solution, identify that an element must be added to or deleted from the bid topology, that an attribute of the element must be revised, or that a rule, constraint, or requirement associated with the element must be revised.

In our previous example, the auctioneer system 205 might revise the bid model by adding the second element required by the received bid. The system 205 might further add rules or constraints to the bid topology that, if necessary, identify a dependency relationship between the first and second elements, or establish a rule for selecting a winning bid for the first element by accounting for the second element when a bid requires such an accounting.

In some embodiments, bid-management tasks described by one or more steps of the iterative process of steps 320-340 may be handled by a distinct Bid Manager module, which may be comprised by auctioneer system 205 or by a larger bid-management system that comprises the system 205 and the Bid Manager.

In step 340, if the bid model or bid topology was revised in step 335, the auctioneer system 205 resolicits bids as a function of the revised bid model. In embodiments in which bids are created, maintained, or submitted by means of automated bidding systems, the bidding systems might respond by revising previously submitted bids as a function of the resolicitation and then resubmitting the revised bids. In some embodiments, a bidding system might further respond to the resolicitation of step 340 by resubmitting bids that do not require revision.

In either case, the method of FIG. 2 would continue with a next iteration of the iterative process of steps 320-340, receiving each resubmitted bid during the next performance of step 325.

In step 345, the system 205 computes the final feasible partial or complete solution. If more than one feasible solution is possible, the system may select a solution that provides greater utility.

Here, utility is the overall value that may be derived from a bid. Utility may be a function of bid prices comprised by a solution or may be based on other characteristics of the bid, such as a degree to which bid attributes satisfy function or nonfunctional requirements of the bid solicitation. In some embodiments, a bid solicitation may comprise one or more functions that are used to determine utility, allowing bidders to better devise bids that provide greater utility. In other embodiments, a function by which utility is computed may be kept secret from some or all bidders.

In some embodiments, a solution may be considered a winning solution if its utility exceeds that of a solution associated with a second-greatest utility value by a certain threshold value.

In step 350, the auctioneer system 205, presents any feasible solutions identified in step 345 to the bidders or to the entities seeking bids. In some embodiments, the final bid model or topology may also be presented to some or all of these entities.

If the system 205 in step 345 was not able to identify a winning complete feasible solution or enough winning partial feasible solutions to sufficiently satisfy project requirements, some or all of the method of FIG. 2 may be repeated until such winning solutions emerge.

What is claimed is:

1. A self-adjusting bid-management system comprising a processor of a computer system, a memory coupled to the processor, and a computer-readable hardware storage device coupled to the processor, the storage device containing program code configured to be run by the processor via the memory to implement a method for a self-adjusting bid-management system, the method comprising:
the processor identifying a bid topology that comprises a set of nodes and a set of edges,
wherein each node of the set of nodes represents a task of a set of project tasks,
wherein a first edge of the set of edges represents a dependency relationship between a first pair of tasks of the set of project tasks, and
wherein the first edge connects a pair of nodes of the set of nodes that represent the first pair of tasks;
the processor building a bid model that comprises the bid topology and a set of project metadata from which may be inferred characteristics of the bid topology;
the processor soliciting a set of bids from a set of bidders;
the processor receiving a first bid from a first bidder in response to the soliciting, wherein the first bid proposes a first bid amount to perform one or more tasks of the set of project tasks;
the processor determining whether the first bid is a winning bid;
the processor ascertaining whether to revise the bid model as a function of the receiving and the determining;
the processor, if having ascertained that the model should be revised, revising the bid model and resoliciting another set of bids from the set of bidders as a function of the revised bid model;
the processor repeating the receiving, the determining, the ascertaining, and the revising and resoliciting until an occurrence of a condition that terminates the bidding process.

2. The system of claim 1, wherein the set of project metadata comprises a constraint that any received bid of the set of bids that comprises a bid on a first task of the set of project tasks must also comprise a bid on a second task of the set of project tasks.

3. The system of claim 1, wherein the set of project metadata comprises a constraint that bars two bidders of the set of bidders from submitting a joint bid.

4. The system of claim 1, wherein the set of project metadata comprises a rule that identifies how the bid model can be revised in response to a received bid.

5. The system of claim 1, wherein the set of project metadata comprises a rule from which the system may determine whether a received bid proposes an infeasible method of performing a task of the set of project tasks.

6. The system of claim 1, wherein the set of project metadata comprises a functional project requirement associated with a first task of the set of project tasks.

7. The system of claim 1, wherein the set of project metadata comprises a nonfunctional project requirement associated with a first task of the set of project tasks.

8. The system of claim 1, wherein the set of project metadata comprises an acceptable range of values of an attribute of a first task of the set of project tasks and wherein a received bid that bids on the first task identifies one or more values of the attribute.

9. The system of claim 1,
wherein the soliciting a set of bids and the resoliciting another set of bids comprises electronically communicating a request for bids to an electronic bidding system of a bidder of the set of bidders,
wherein a bid received from the electronic bidding system in response to the request for bids is limited as a function of an element of metadata of the set of project metadata, and
wherein the request for bids comprises bid-limiting information from which the electronic bidding system may infer a limitation comprised by the element of metadata.

10. The system of claim 1, wherein the revising comprises a step selected from a group comprising: adding a new node to the bid topology, deleting an existing node from the bid topology, or revising an element of metadata of the set of project metadata.

11. The system of claim 1, wherein the processor ascertains that the bid model should not be revised because the processor determined that the first bid is not a winning bid.

12. The system of claim 1,
wherein the condition is an identification of one or more solutions that together completely satisfy all project requirements associated with the most recent bid solicitation, and
wherein each solution of the one or more solutions identifies one or more winning bids.

13. A method for a self-adjusting bid-management system, the method comprising:
a processor of the bid-management system identifying a bid topology that comprises a set of nodes and a set of edges,
wherein each node of the set of nodes represents a task of a set of project tasks,
wherein a first edge of the set of edges represents a dependency relationship between a first pair of tasks of the set of project tasks, and
wherein the first edge connects a pair of nodes of the set of nodes that represent the first pair of tasks;
the processor building a bid model that comprises the bid topology and a set of project metadata from which may be inferred characteristics of the bid topology,
the processor soliciting a set of bids from a set of bidders;
the processor receiving a first bid from a first bidder in response to the soliciting, wherein the first bid proposes a first bid amount to perform one or more tasks of the set of project tasks;
the processor determining whether the first bid is a winning bid;
the processor ascertaining whether to revise the bid model as a function of the receiving and the determining;
the processor, if having ascertained that the model should be revised, revising the bid model and resoliciting another set of bids from the set of bidders as a function of the revised bid model;
the processor repeating the receiving, the determining, the ascertaining, and the revising and resoliciting until an occurrence of a condition that terminates the bidding process.

14. The method of claim 13, wherein the set of project metadata is selected from a group consisting of:
a constraint that any received bid of the set of bids that comprises a bid on a first task of the set of project tasks must also comprise a bid on a second task of the set of project tasks;
a constraint that bars two bidders of the set of bidders from submitting a joint bid;
a rule that identifies how the bid model can be revised in response to a received bid;
a rule from which the system may determine whether a received bid proposes an infeasible method of performing a task of the set of project tasks.
a functional or nonfunctional project requirement associated with a first task of the set of project tasks; and
an acceptable range of values of an attribute of a first task of the set of project tasks and wherein a received bid that bids on the first task identifies one or more values of the attribute.

15. The method of claim 13,
wherein the soliciting a set of bids and the resoliciting another set of bids comprises electronically communicating a request for bids to an electronic bidding system of a bidder of the set of bidders,
wherein a bid received from the electronic bidding system in response to the request for bids is limited as a function of an element of metadata of the set of project metadata, and
wherein the request for bids comprises bid-limiting information from which the electronic bidding system may infer a limitation comprised by the element of metadata.

16. The method of claim 13, wherein the revising comprises a step selected from a group comprising: adding a new node to the bid topology, deleting an existing node from the bid topology, or revising an element of metadata of the set of project metadata.

17. The method of claim 13, further comprising providing at least one support service for at least one of creating, integrating, hosting, maintaining, and deploying computer-readable program code in the computer system, wherein the computer-readable program code in combination with the computer system is configured to implement the identifying, the building, the soliciting, the receiving, the determining, the ascertaining, and the revising and resoliciting.

18. A computer program product, comprising a computer-readable hardware storage device having a computer-readable program code stored therein, the program code configured to be executed by a self-adjusting bid-management system comprising a processor, a memory coupled to the processor, and a computer-readable hardware storage device coupled to the processor, the storage device containing program code configured to be run by the processor via the memory to implement a method for a self-adjusting bid-management system, the method comprising:
the processor identifying a bid topology that comprises a set of nodes and a set of edges,
wherein each node of the set of nodes represents a task of a set of project tasks,
wherein a first edge of the set of edges represents a dependency relationship between a first pair of tasks of the set of project tasks, and
wherein the first edge connects a pair of nodes of the set of nodes that represent the first pair of tasks;
the processor building a bid model that comprises the bid topology and a set of project metadata from which may be inferred characteristics of the bid topology;
the processor soliciting a set of bids from a set of bidders;
the processor receiving a first bid from a first bidder in response to the soliciting, wherein the first bid proposes a first bid amount to perform one or more tasks of the set of project tasks;
the processor determining whether the first bid is a winning bid;
the processor ascertaining whether to revise the bid model as a function of the receiving and the determining;
the processor, if having ascertained that the model should be revised, revising the bid model and resoliciting another set of bids from the set of bidders as a function of the revised bid model;
the processor repeating the receiving, the determining, the ascertaining, and the revising and resoliciting until an occurrence of a condition that terminates the bidding process.

19. The computer program product of claim 18, wherein the set of project metadata is selected from a group consisting of:
a constraint that any received bid of the set of bids that comprises a bid on a first task of the set of project tasks must also comprise a bid on a second task of the set of project tasks;
a constraint that bars two bidders of the set of bidders from submitting a joint bid;
a rule that identifies how the bid model can be revised in response to a received bid;
a rule from which the system may determine whether a received bid proposes an infeasible method of performing a task of the set of project tasks.
a functional or nonfunctional project requirement associated with a first task of the set of project tasks; and
an acceptable range of values of an attribute of a first task of the set of project tasks and wherein a received bid that bids on the first task identifies one or more values of the attribute.

20. The computer program product of claim 18,
wherein the soliciting a set of bids and the resoliciting another set of bids comprises electronically communicating a request for bids to an electronic bidding system of a bidder of the set of bidders,
wherein a bid received from the electronic bidding system in response to the request for bids is limited as a function of an element of metadata of the set of project metadata, and
wherein the request for bids comprises bid-limiting information from which the electronic bidding system may infer a limitation comprised by the element of metadata.
